(19) United States
(12) Patent Application Publication
(10) Pub. No.: US 2023/0421233 A1
(43) Pub. Date: Dec. 28, 2023

(54) TRANSMISSION METHOD, MULTI-TRP/PANEL SYSTEM AND UE

(71) Applicant: JRD COMMUNICATION (SHENZHEN) LTD., Shenzhen, Guangdong (CN)

(72) Inventors: Tian Li, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 18/249,235

(22) PCT Filed: Oct. 16, 2020
(86) PCT No.: PCT/CN2020/121643

§ 371 Date: Apr. 14, 2023

(51) Int. Cl. H04B 7/06; H04B 7/024; H04L 5/00

(52) U.S. Cl. CPC H04B 7/0695; H04B 7/024; H04L 5/0023; H04L 5/0053; H04L 5/0058

(57) ABSTRACT

Method, system, and UE for PUCCH transmission with repetition in multi-TRP/panel systems are proposed, enabling the UE to support PUCCH repetitions in a system comprising multiple TRPs. To implement PUCCH repetition in the multi-TRP/panel based systems, solutions include combinations of default spatial relation assumption, configuration/activation of multiple spatial relations, and intra-slot PUCCH repetition. One or two default spatial relations (settings) are assumed, so that a UE can perform PUCCH transmissions with multiple TRPs when no spatial relation is configured. The MAC CE may be enhanced to carry information of multiple PUCCH resources and corresponding spatial relations so that a UE can perform PUCCH transmissions with multiple TRPs without confusions. Intra-slot PUCCH repetition is proposed to improve efficiency and reliability of PUCCH transmissions by repeating the Uplink Control Information (UCI) within one slot.

### BACKGROUND

This invention is related to wireless communication systems operating in multiple input multiple output (MIMO) systems, and particularly, to improvement of Physical Uplink Control Channel (PUCCH) transmissions with repetition in multiple transmission-reception point (TRP)/panel based systems.

To exploit multiple path propagation, the MIMO technology multiplies the capacity of a radio link by deploying multiple transmission and receiving antennas at the transmitter end and the receiver end. More than one data signal is simultaneously transmitted and received over the same radio channel, thereby significantly improving performance of spectral efficiency. The technology has been developed into the multi-TRP/panel based systems.

In Rel-15, to satisfy different Block Error Rate (BLER) targets, feedback delay and coverage requirements, five Physical Uplink Control Channel (PUCCH) formats were defined to convey Uplink Control Information (UCI) from 1 bit to hundreds of bits depending on the UCI types such as ACK/NACK, Scheduling Request (SR), Long Range Radar (LRR) and Channel State Information (CSI). In conventional single TRP based systems, an inter-slot PUCCH repetition (procedure) was defined for PUCCH format 1, 3, or 4 to further enhance the coverage, where the number of slots for PUCCH repetition is configured by high layer parameter nrofSlots.

In conventional inter-slot PUCCH repetitions, frequency hopping can be configured within a slot or across slots to fully exploit the frequency diversity. For a UE in Rel-16, more than one Hybrid Automatic Repeat Request Acknowledgement (HARQ-ACK) codebooks intended for different service types can be generated simultaneously, and more than one PUCCH for HARQ-ACK transmission within a slot was supported.

For a UE connected to a multi-TRP system, PUCCH repetitions can be scheduled in different transmission occasions toward different TRPs so that the UE has multiple chances to transmit the same UCI. A PUCCH repetition can be based on Time Division Multiplexing (TDM), Frequency Division Multiplexing (FDM), or Space Division Multiplexing (SDM). PUCCH repetition targeting towards different TRPs can avoid possible blockage between any TRP and the UE, such that the reliability is improved while the coverage is enlarged.

In Rel-16, spatial relations for PUCCH resources are configured by the high layer. One of the spatial relations corresponding to a PUCCH resource/resource group is activated by a Medium Access Control (MAC) control element (CE), indicating the UE a specific spatial domain transmission filter corresponding to a PUCCH transmission.

In single-TRP systems according to Rel-16, if a high layer parameter enableDefaultBeamPlForPUCCH is configured to enable a default spatial relation for a PUCCH transmission from a UE while no spatial relation is configured for the PUCCH resource, a spatial relation for the PUCCH transmission is deemed the same as a spatial setting for a PDCCH reception by the UE in the Control Resource Set (CORESET) with the lowest ID on the active DL BWP. In multi-TRP/panel based systems, however, a PDCCH transmission can be configured with two different Transmission Configuration Indicator (TCI) states. Therefore, when the UE does not have sufficient information about spatial relation of a PUCCH resource, it is desirable for the UE to be capable to assume a default spatial relation based on existed information.

### SUMMARY

A detailed description is given in the following embodiments with reference to the accompanying drawings.

Embodiments of a method for PUCCH transmission with repetition in multi-TRP/panel systems are proposed, enabling a user equipment (UE) to support PUCCH repetitions in a system comprising multiple TRPs.

To enable PUCCH repetition in the multi-TRP/panel based systems, the proposed solutions include default spatial relation assumption, configuration/activation of multiple spatial relations, and intra-slot PUCCH repetition.

In one aspect of the invention, one or two default spatial relations (settings) are assumed, so that a UE can perform PUCCH transmissions with multiple TRPs when no spatial relation is configured.

In another aspect of the invention, the MAC CE may be enhanced to indicate spatial relations of multiple PUCCH resources so that a UE can perform PUCCH transmissions with multiple TRPs without confusions.

In a further aspect of the invention, intra-slot PUCCH repetition is proposed to improve efficiency and reliability of PUCCH transmissions by repeating the Uplink Control Information (UCI) within one slot. Embodiments include several sub-topics, comprising but not limited to indication of the number of repetitions, design of the first symbol, indication of repetition type and design of an overlap rule between intra-slot PUCCH and other PUCCH.

By combination of one or more of the described solutions, PUCCH transmissions/repetitions in multi-TRP/panel based systems can be implemented with great performance improvement over conventional protocols.

Embodiments of a transmission method are provided, for a UE operatable in a multi-TRP/panel system comprising a plurality of TRPs and a high layer. Embodiments of the TRP/panel system and the UE jointly implementing the transmission method are also provided. A summary of the UE and the multi-TRP/panel system jointly implementing the transmission method, is described hereafter.

The multi-TRP/panel system comprises a high layer and a plurality of TRPs simultaneously accessible by the UE, allowing the UE to transmit multiple repetitions of a PUCCH.

When the multi-TRP/panel system issues a parameter indicating that a default spatial relation for a PUCCH to be transmitted is enabled while the UE is not configured with any spatial relation for the PUCCH, the UE performs a default spatial relation assumption to determine a default spatial relation as a basis to performing a PUCCH transmission towards the plurality of TRPs; wherein the spatial relation defines relationships between the plurality of TRPs and PUCCH resource for the PUCCH transmission.

If one or more PUCCH repetition(s) is/are configured when the PUCCH is configured with a spatial relation, the spatial relation is analogically applied to each PUCCH transmission of the repetitions.

The multiple repetitions of PDCCH may be transmitted in different search space sets or different PDCCH candidates in one CORESET. When the multiple repetitions are transmitted by different TRPs, one CORESET is configured or activated with two TCI states.

In an embodiment, when multiple PDCCH repetitions of a PDCCH are transmitted by different TRPs, a CORESET of lowest CORESET ID is determined in a most recent monitored search space. The default spatial relation assumption is performed to determine the default spatial relation based on a spatial setting for PDCCH receptions by the UE in the CORESET of lowest ID. If the CORESET of lowest CORESET ID comprises two active TCI states, the spatial setting is corresponded to one of the two TCI states having a lower TCI state ID.

In another embodiment, a PDCCH candidate is defined in two different CORESETs each corresponding to an active TCI state. A CORESET of lowest CORESET ID is determined in a most recent monitored duration of the two different CORESETs. The default spatial relation assumption is performed to determine the default spatial relation based on a spatial setting for PDCCH receptions by the UE in the CORESET of lowest CORESET ID on the active DL BWP

When the high layer indicates that a default spatial relation for a PUCCH to be transmitted is enabled while the UE is not configured with any spatial relation for the PUCCH, a PDCCH candidate of lowest ID may be determined from a most recent monitored search space. If the PDCCH candidate is associated with one TCI state, corresponding a spatial setting for the PDCCH reception to the TCI state. If the PDCCH candidate is associated with two TCI states, corresponding the spatial setting to one of the two TCI states having a lower TCI state ID. The default spatial relation assumption may be performed to determine the default spatial relation based on the spatial setting.

The multi-TRP/panel system may be a FDM system, and different sets of REGs/REG bundles/CCEs of a CORESET may have different TCI states. The multi-TRP/panel system transmits different CCEs/REGs of a PDCCH candidate by the TRPs, with different part of coded bits of a DCI transmitted in each CCE/REG. The UE may perform the default spatial relation assumption to determine the default spatial relation for a PUCCH transmission from the UE based on a spatial setting for PDCCH receptions by the UE, wherein the spatial setting corresponds to TCI states of a REG/REG bundles/CCE with a lowest ID in the PDCCH candidate.

Conventionally, only one default spatial relation is assumed in the absence of a default spatial relation. An embodiment proposes assumptions of two default spatial relations. In the case when the high layer indicates that a default spatial relation for a PUCCH to be transmitted is enabled while the UE is not configured with any spatial relation for the PUCCH, when a PDCCH reception is configured with two TCI states and the UE is configured with one or more PUCCH repetitions, the default spatial relation assumption may be performed to determine two default spatial relations based on the two TCI states to transmit each PUCCH repetition through different TRPs respectively. Specifically, the two TCI states are determined in a most recent monitored search space, and the two default spatial relations are determined based on spatial settings corresponding to the two TCI states, respectively.

The UE may recursively apply one of the two default spatial relations to each of the repetitions of the PUCCH in a cyclical mapping fashion.

In an embodiment of the multi-TRP/panel system which allocates multiple PUCCH resources each corresponding to a different TRP, the UE can support one or more spatial relations corresponding to the multiple PUCCH resources and the TRPs for each repetition of the PUCCH. The UE transmits repetitions of the PUCCH towards different TRPs based on the one or more spatial relations respectively.

When the UE is configured with multiple PUCCH repetitions, the UE derives a timing indicator K₁ based on a DCI for a first PUCCH resource, and determines a next available transmission occasion based on the timing indicator K₁ for a second PUCCH resource. The multi-TRP/panel system manipulates a PUCCH spatial relation activation/deactivation MAC CE to indicate at least the first and second PUCCH resources and corresponding spatial relation. The PUCCH spatial relation activation/deactivation MAC CE comprises a first PUCCH resource ID with a first reserved bit, and a first spatial relation field.

The multi-TRP/panel system manipulates a PUCCH spatial relation activation/deactivation MAC CE by the following steps. A second PUCCH resource ID with a second reserved bit are added, a second spatial field is added. The i^{th} bit of the second spatial field is set to 1 to indicate the second PUCCH spatial relation with the high parameter PUCCH-SpatialRelationInfold equal to i+1 is activated, and 0 for deactivation vice versa. If the second reserved bit is set to 1, a second PUCCH resource indicator is indicated by the second PUCCH resource ID, and the corresponding spatial relations is activated/deactivated according to the second spatial field. If the second reserved bit is set to 0, the second PUCCH resource ID and the second spatial field are disabled/ignored. It is to be understood that the bit values is not limited to 0 and 1 as described in the embodiment and other value settings can be possible.

The multi-TRP/panel system manipulates a PUCCH spatial relation activation/deactivation MAC CE by the following steps. A second PUCCH resource ID with a second reserved bit is added. A first portion of the first spatial relation field (i.e., first 4 bits) is used to indicate spatial relations for the first PUCCH resource; and a second portion of the first spatial relation field (i.e., last 4 bits) is used to indicate spatial relations for the second PUCCH resource. If the second reserved bit is set to 1, a second PUCCH resource indicator is indicated by the second PUCCH resource ID, and the corresponding spatial relations is activated/deactivated according to the first spatial relation field. If the second reserved bit is set to 0, the second PUCCH resource ID and the first spatial relation field are disabled/ignored.

The multi-TRP/panel system designs a group based MAC CE based on an enhanced PUCCH spatial relation activation/deactivation MAC CE, which comprises a second PUCCH resource ID with a corresponding reserved bit, and a second spatial relation info ID for indicating spatial relation information. The multi-TRP/panel system uses a DCI to indicate the first PUCCH resource, uses the group based MAC CE to indicate the second PUCCH resource, and groups the first and the second PUCCH resource in the same PUCCH resource group. If the second reserved bit is set to 1, the UE extracts the value in the second PUCCH resource ID to be a second PUCCH resource indicator, and activates/deactivates corresponding spatial relation based on the second spatial relation info ID. If the second reserved bit is set to 0, which means that the second PUCCH resource ID and the second spatial relation info ID are disabled, so that the UE shall ignore the second PUCCH resource ID and the second spatial relation info ID.

To perform an intra-slot PUCCH repetition for the PUCCH, the multi-TRP/panel system may configure a number of repetitions which may be indicated by a high layer signaling.

A method is needed to signal the number of repetition. The number of repetition configured by the higher layer may not be suitable for different scenarios, especially when the channel changes dynamically. If the number of repetition is configured by the high layer, an actual number of repetition can be flexibly indicated by a MAC CE. An embodiment of the multi-TRP/panel system enhances a PUCCH spatial relation activation/deactivation MAC CE to indicate the UE the actual number of repetitions by defining three value fields to indicate 2, 4 and 8 respectively. The actual number is indicated based on one of the value fields set to 1, whereas other value fields set to 0 are ignored.

The multi-TRP/panel system further enhances the PUCCH spatial relation activation/deactivation MAC CE by the following steps. A type field is defined in the PUCCH spatial relation activation/deactivation MAC CE. If type field is set to 1, the intra-slot PUCCH repetition is configured. Conversely, if type field is set to 0, an inter-slot PUCCH repetition is configured. Wherein the actual number of repetitions is not larger than the number of repetitions.

The repetition of PUCCH comprises two repetition types, inter-slot repetition and intra-slot repetition; and the multi-TRP/panel system further indicates the repetition type by the number of repetitions, or different PUCCH formats. For example, the short PUCCH (format 0, 2) indicates the intra-slot repetition and long PUCCH (format 1,3,4) indicates inter-slot repetition.

In an embodiment, two different fields may be employed to indicate the number of repetitions respective to the two repetition types. The repetition type can also be represented based on the two fields. For example, if only one field is greater than 1, the type indicated by the field is used to represent the repetition type.

If the repetition type cannot be implicitly indicated, the multi-TRP/panel system adds one field to explicitly indicate the repetition type, wherein: the field is added in a high layer signaling, a MAC CE or a DCI; and if the field is set to 1, the intra-slot repetition is configured, otherwise, the inter-slot repetition is configured. A reverse embodiment may be possible, that is, a field of 1 for inter-slot repetition, and 0 for intra-slot repetition.

When an intra-slot PUCCH repetition is configured for the PUCCH, the multi-TRP/panel system uses a high layer parameter startingSymbolIndex to indicate the first PUCCH repetition, wherein: the first symbol of the first repetition is startingSymbolIndex symbols from the beginning of the slot indicated by the timing indicator K₁.
if the end of a last repetition is regarded as the reference point, the multi-TRP/panel system uses the high layer parameter startingSymbolIndex to indicate the first symbol of the second and remaining repetitions; wherein: the first symbol of the second and remaining repetition is startingSymbolIndex symbols from the reference point.
if the beginning of a dedicated symbol is regarded as the reference point, the multi-TRP/panel system uses the high layer parameter startingSymbolIndex to indicate the first symbol of the second and remaining repetitions; wherein: the first symbol of the second and remaining repetitions is startingSymbolIndex symbols from the reference point.

The multi-TRP/panel system configures a series of reference points for the second and remaining repetitions, wherein: the series of reference points are indicated by a high layer parameter, a MAC CE, or a DCI; and the series of reference points are recursively applied in sequence for the remaining repetitions.

If the end of the last repetition is regarded as the reference point, the multi-TRP/panel system uses a value Gab to indicate the first symbol of the second and remaining repetitions; the multi-TRP/panel system adds a new field in a high layer parameter, a MAC CE, or a DCI to indicate the value Gab to the UE. Specifically, the first symbol of the second and remaining repetition is Gab symbols from the reference point.

When an intra-slot PUCCH repetition is configured for the PUCCH, the multi-TRP/panel system provides an overlap rule defining a priority level based on the UCI priority orders: HARQ-ACK>SR>CSI with higher priority>CSI with lower priority; and when a first sub-slot PUCCH with more than one sub-slot and at least a second PUCCH with one or more sub-slots are overlapped on one or more sub-slots, the UE applies the overlap rule to prioritize all PUCCH transmissions accordingly.

If the first PUCCH and any of the second PUCCHs are not of the same priority, in each overlapping sub-slot, the UE transmits a PUCCH of higher priority, but does not transmit those with lower priorities.

In an embodiment of the multi-TRP/panel system, the overlap rule prescribes that all repetitions of a same PUCCH in one slot are on the same priority. If a PUCCH has the highest priority among all overlapped PUCCHs in the slot, all PUCCH repetitions of the PUCCH are transmitted, whereas all other overlapped PUCCHs are dropped.

A deferral mechanism may be provided. If a PUCCH has a lower priority than other overlapped PUCCHs in the slot, the PUCCH is saved or buffered as a deferred PUCCH. A vacancy duration may be determined from the end of a higher priority PUCCH to the beginning of a next higher priority PUCCH in the same slot, or from the end of the higher priority PUCCH to the end of the slot if there is no other higher priority PUCCH thereafter. If a number of consecutive symbols of the deferred PUCCH is small enough to fit in the vacancy duration, the deferred PUCCH is transmitted in the vacancy duration after the higher priority PUCCH finishes transmission.

In an embodiment implemented on a sub-slot basis, when a first and a second PUCCH of the same priority are overlapped on one or more sub-slots, the UE transmits a PUCCH having an earlier start symbol, but does not transmit a PUCCH with a later start symbol.

In an embodiment if a sub-slot based first PUCCH and one or more second PUCCHs are on the same priority, the overlap rule directs the UE to execute the steps of: if a first PUCCH starts at a later symbol, deferring the first PUCCH by saving or buffering, determining a vacancy duration from the end of an early started PUCCH to the beginning of a next PUCCH in the same slot, or from the end of the early started PUCCH to the end of the slot if there is no other PUCCH thereafter, and if a number of consecutive symbols of the first PUCCH is small enough to fit in the vacancy duration, transmitting the first PUCCH in the vacancy duration after the early started PUCCH finishes transmission.

An embodiment of a UE comprises a processor, a transmitter, a receiver, a memory and a storage medium, connectible to a multi-TRP/panel system comprising a high layer and a plurality of TRPs simultaneously accessible by the UE, the UE being operable to perform the embodiment of transmission method incorporated with the multi-TRP/panel system. Since the details are focused on the method already introduced above, further description of the UE would not be repeated herein.

The subject application in summary renders at least the following effects. Definition of a default PUCCH spatial relation, configuration of multiple PUCCH resource and the corresponding spatial relations, and definition of the intra-slot PUCCH repetition in multi-TRP/panel based systems.

### BRIEF DESCRIPTION OF THE DRAWINGS

The invention can be more fully understood by reading the subsequent detailed description and examples with references made to the accompanying drawings, wherein:

FIG. 1 shows a system architecture of a multi-TRP/panel system comprising a plurality of TRPs simultaneously accessible by a UE according to an embodiment of the invention.

FIG. 2 is a flow chart of the three inventive aspects proposed to accomplish the PUCCH transmission in the multi-TRP/panel system according to embodiments of the invention.

FIG. 3 shows resource allocation in a time-frequency chart according to an embodiment of the invention.

FIG. 4 is a flowchart of default spatial relation assumption according to an embodiment of the invention.

FIG. 5 shows a manipulation of the PUCCH spatial relation activation/deactivation MAC CE according to an embodiment of the invention.

FIG. 6 shows another manipulation of the PUCCH spatial relation activation/deactivation MAC CE according to an embodiment of the invention.

FIG. 7 shows an enhanced PUCCH spatial relation activation/deactivation MAC CE according to an embodiment of the invention.

FIG. 8 is a flowchart of configuration/activation of multiple spatial relations according to an embodiment of the invention.

FIG. 9 shows a manipulation of the PUCCH spatial relation activation/deactivation MAC CE for indicating the number of repetitions according to an embodiment of the invention.

FIG. 10 shows an alternative MAC CE for indicating the number of repetitions according to an embodiment of the invention.

FIGS. 11A and 11B show time slots of a PDCCH 1100, a PDSCH 1120 and two PUCCHs 1140 according to an embodiment of the invention.

FIG. 12 shows time slots where two PUCCHs starting at different symbols in the same slot according to an embodiment of the invention.

FIGS. 13˜15 show time slots for a slot based PUCCH S0 and a sub-slot based PUCCH with two repetitions SS1 according to an embodiment of the invention.

FIG. 16 is a flowchart summarizing the steps implemented in intra-slot repetition according to embodiments of the invention.

FIG. 17 is a diagram of a UE 1700 according to the embodiment of the application.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

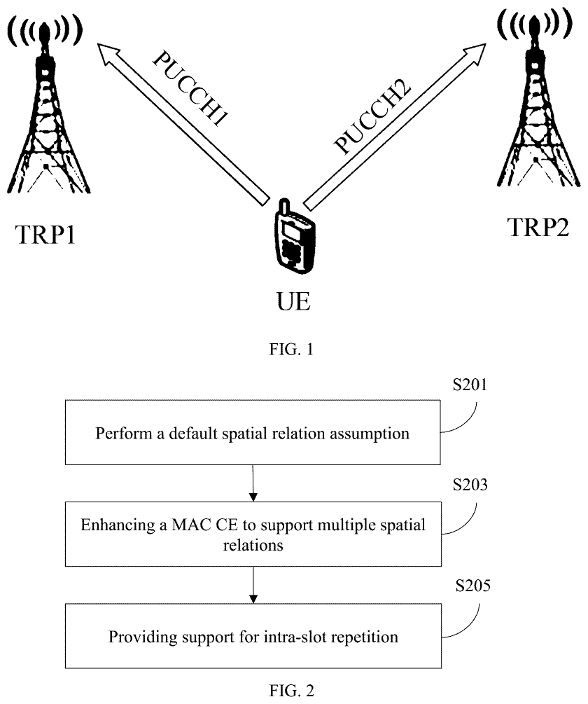

FIG. 1 shows a system architecture of a multi-TRP/panel system comprising a plurality of TRPs simultaneously accessible by a UE according to an embodiment of the invention. Multiple PUCCH transmissions may be performed toward different TRPs. For example, a first PUCCH transmission PUCCH1 is transmitted to a first TRP TRP1 while a second PUCCH transmission PUCCH2 is transmitted to a second TRP TRP2. To enable PUCCH repetition in the multi-TRP/panel based systems, the proposed solutions include default spatial relation assumption, configuration/activation of multiple spatial relations, and intra-slot PUCCH repetition.

FIG. 2 is a flow chart of the three inventive aspects proposed to perform the PUCCH transmission in the multi-TRP/panel system according to embodiments of the invention.

In step S201, one or two default spatial relations are assumed, so that a UE can perform PUCCH transmissions with multiple TRPs when no spatial relation is configured.

In step S203, the MAC CE may be enhanced to indicate information of spatial relations for multiple PUCCH resources so that a UE can perform PUCCH transmissions with multiple TRPs without confusions.

In step 205, intra-slot PUCCH repetition is proposed to improve efficiency and reliability of PUCCH transmissions by repeating the Uplink Control Information (UCI) within one slot.

Detailed embodiments of default spatial relation assumptions are described hereafter. A spatial relation can be determined (assumed) based on CORESET, PDCCH candidate, or Control Channel Element (CCE)/Resource Element Group (REG). In the current application, by default spatial relation assumption, it means that a spatial relation is determined based on the CORESET, the PDCCH candidate, and/or the Control Channel Element (CCE)/Resource Element Group (REG), to serve as a default spatial relation which allows the UE to perform PUCCH transmissions correctly in the case when information of actual default spatial relation is absent for the UE.

In the first aspect of the invention, at least one default PUCCH spatial relation is assumed when the UE is not configured with a spatial relation required for a PUCCH transmission.

Conventionally, a default spatial relation for a PUCCH is designed based on only one TCI associated with a single-TRP based PDCCH transmission. In multi-TRP/panel based systems, however, a PDCCH transmission can be configured with two different TCI states. On the other hand, for a PUCCH to be transmitted from a UE within a multi-TRP/panel based system, if a high layer parameter enableDefaultBeamPlForPUCCH indicates that a default spatial relation for the PUCCH is enabled, a spatial relation needs to be specified when the UE is not configured with any spatial relation for a PUCCH resource. In an embodiment, a default spatial relation assumption is performed to determine one or two default spatial relation(s) for PUCCH based on the one or two TCI states in the PDCCH.

A case of only one spatial relation for the PUCCH transmission is described hereafter. For a PUCCH to be transmitted in a multi-TRP/panel based system, if one or more repetition(s) is/are configured, the same spatial relation is applied to each PUCCH transmission of the repetitions. In the case to be described hereafter, the spatial relation is referred to as the default spatial relation which will be described in the following embodiments.

In an embodiment, the default spatial relation can be determined based on one CORESET with two active TCI states.

Multiple repetitions of PDCCH may be transmitted in different search space sets or different PDCCH candidates in one CORESET. The CORESET may be configured or activated with two TCI states when the PDCCH repetitions are transmitted by different TRPs.

In the case when one CORESET is configured with two active TCI states, preferably, a default spatial relation assumption is performed to determine a default spatial relation for PUCCH transmission. Specifically, when multiple PDCCH repetitions of a PDCCH are transmitted by different TRPs, a CORESET of lowest CORESET ID is determined in a most recent monitored search space. The default spatial relation assumption is performed to assume that the default spatial relation is the same as a spatial setting for PDCCH receptions by the UE in the CORESET of lowest ID. If the CORESET of lowest CORESET ID comprises two active TCI states, the spatial setting is corresponded to one of the two TCI states having a lower TCI state ID.

In another embodiment, the default spatial relation may be determined based on two different CORESETs each corresponding to an active TCI states. In Rel-16, a DCI transmission is determined by the duration of a CORESET.

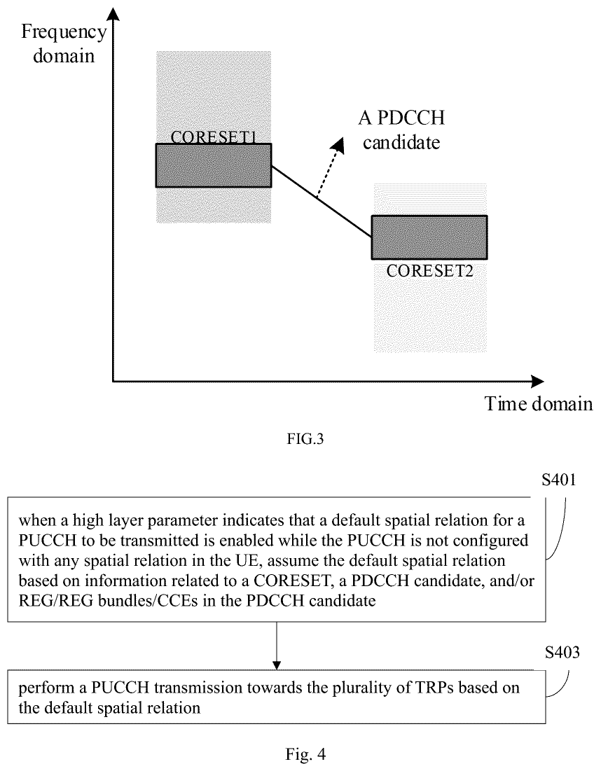

FIG. 3 shows resource allocation in a time-frequency chart according to an embodiment of the invention. If a PDCCH candidate is defined in two different CORESETs, with each CORESET corresponding to an active TCI state, the duration for the DCI transmission is determined within durations of the two CORESETs, i.e., from the start of CORESET1 to the end of CORESET2. Thereafter, the PDCCH candidate is used for the DCI transmission. In FIG. 3, it is shown PDCCH resources are allocated over a frequency-time domain. A PDCCH candidate may be allocated between the durations of the two CORSETs, CORSET1 and CORSET 2. Since there are two active TCI states, each repetition of the PDCCH can be selectively configured with one of the active TCI states.

In another embodiment, a PDCCH candidate is defined in two different CORESETs each corresponding to an active TCI state. In that case, a CORESET of lowest CORESET ID is determined in a most recent monitored duration of the two different CORESETs. The default spatial relation assumption is performed to determine the default spatial relation based on a spatial setting for PDCCH receptions by the UE in the CORESET of lowest CORESET ID on the active DL BWP.

FIG. 4 is a flowchart of default spatial relation assumption according to an embodiment of the invention. The steps to assume a spatial relation are summarized as below. In step S401, when a high layer parameter indicates that a default spatial relation for a PUCCH to be transmitted is enabled while the UE is not configured with any spatial relation for the PUCCH in the UE, the default spatial relation is assumed based on information related to a CORESET, a PDCCH candidate, and/or REG/REG bundles/CCEs in the PDCCH candidate. In step S403, a PUCCH transmission is performed towards the plurality of TRPs based on the default spatial relation assumption.

In an alternative embodiment, the default spatial relation can be determined based on PDCCH candidates. In the case that a PDCCH repetition is configured with two active TCI states, one PDCCH candidate may be selectively associated with one or two TCI states. One embodiment is to directly apply the associated TCI state for PUCCH transmission. Preferably, a default spatial relation assumption is performed to assume that a default spatial relation for PUCCH transmission from a UE is the same as a spatial setting for PDCCH reception by the UE. A PDCCH candidate of lowest ID is determined from a most recent monitored search space. If the PDCCH candidate is associated with one TCI state, the spatial setting is associated to the TCI state corresponding to the PDCCH candidate. If the PDCCH candidate is associated with two TCI states, the spatial setting is associated to one of the two TCI states that has a lower TCI state ID.

In a further embodiment, the default spatial relation can be determined based on REG/REG bundles/CCEs. For FDM based multi-TRP PDCCH, multiple TRPs would transmit different CCEs/REGs of a PDCCH candidate. In other words, multiple TRPs transmit different part of coded bits of a DCI in different CCEs/REGs. As a result, different REG/REG bundle/CCE sets of the CORESET would have different TCI states. Preferably, a REG/REG bundles/CCE of lowest ID is determined from the PDCCH candidate, and a default spatial relation for PUCCH transmission from a UE may be assumed to be the same as a spatial setting for PDCCH receptions by the UE. Wherein the spatial setting is corresponded to a TCI state of one of the REG/REG bundle/CCE of lowest ID.

Embodiments of two spatial relations for the PUCCH transmission are described hereafter. In Rel-16, when a spatial relation of a PUCCH resource is not configured and a PUCCH is transmitted over multiple slots, a same spatial setting is applied to each of the slots in the PUCCH transmission. To fully exploit the spatial diversity and avoid the possible blockage between the TRPs and the UE, it is preferable to employ two default spatial relations for PUCCH repetitions toward different TRPs.

Since a PDCCH is configured with two TCI states, one embodiment is to directly use the two spatial settings for PUCCH repetition. Preferably, two spatial relations can be applied to each transmission occasion of the PUCCH repetition, and two default spatial relations for PUCCH transmissions of a UE are assumed to be the same as the two spatial settings for PDCCH receptions by the UE. Specifically, the two TCI states are determined in a most recent monitored search space, and the two default spatial relations are determined based on spatial settings corresponding to the two TCI states, respectively.

In an embodiment of multiple PUCCH repetitions, a mapping order for the default spatial relation is provided. For example, the mapping order is a cyclical mapping. For example, the first and the second spatial relations are applied to the first and second PUCCH transmission occasions respectively. If the number of repetitions is larger than two, the same spatial relation mapping applies to the following PUCCH transmission occasions. In other words, if no spatial relation is configured for PUCCH while two default spatial relations for PDCCH are configured, the cyclical mapping is applied to determine how the two default spatial relations are applied to the multiple PUCCH repetitions.

Embodiments of configuration/activation of multiple spatial relations are described hereafter. Inter-slot PUCCH repetition in single TRP based systems has been supported in Rel-15. With the same resource allocation in each slot, a UE may use the same beam to repeat the PUCCH transmission in consecutive slots. The PUCCH resources are typically configured by the high layer through signaling. For example, a PUCCH Resource Indicator (PRI) field in the DCI can indicate a dedicated PUCCH resource, and a MAC CE can also be used to indicate a single spatial relation for a particular PUCCH resource. The PUCCH repetitions can be configured with different beams in Rel-17 multi-TRP scenario, so as to obtain the spatial diversity and reliability. That is, PUCCH repetitions are transmitted towards different TRPs, with spatial relations of each PUCCH repetition associated to different TRPs respectively. In conventional design, however, a DCI can only indicate one PRI, and a MAC CE can only update one PUCCH spatial relation. Therefore, a mechanism supporting multiple PUCCH resources and corresponding spatial relations is desirable.

In multi-TRP/panel based systems, PUCCH repetitions are transmitted towards different TRPs, so that the spatial relation of each PUCCH repetition should correspond to different TRPs. The usage of multiple PUCCH resources allows different PUCCH resources to be transmitted toward different TRPs, such that the PUCCH resource can be flexibly allocated across PUCCH repetition. For example, different PUCCH format can be configured for multiple repetitions of the PUCCH. To enable multiple spatial relations, supports of multiple PUCCH resource and corresponding spatial relations are required. The following embodiments illustrate how to indicate the multiple PUCCH resources and update the corresponding spatial relations.

One embodiment to enable multiple PUCCH resource allocation for PUCCH repetition, is to enlarge the PRI field of a DCI so that multiple PUCCH resources can be specified. Such an approach, however, causes the size of DCI to be undesirably enlarged. A preferred embodiment is proposed without changing the DCI size. AMAC CE can be slightly manipulated to indicate different PUCCH resources and corresponding spatial relations. Such a MAC CE manipulation is advantageous for causing neglectable affections to the regular communications.

When a UE is configured with PUCCH repetition, the UE derives a timing indicator K₁ for the first PUCCH resource based on the DCI, and then determines a next available transmission occasion for the second PUCCH resource based on the timing indicator K₁.

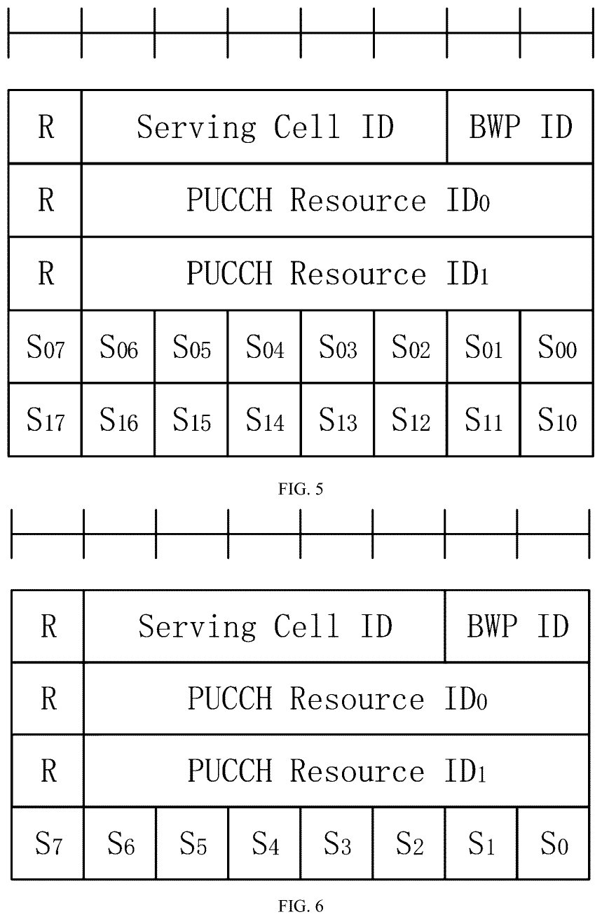

FIG. 5 shows a manipulation of the PUCCH spatial relation activation/deactivation MAC CE. In FIG. 5, a PUCCH spatial relation activation/deactivation MAC CE is manipulated by adding a PUCCH resource ID₁ with a corresponding spatial relation S₁ᵢ.

When a UE receives high layer parameter requesting a PUCCH repetition, essential information including PUCCH resources and corresponding spatial relations are required by the UE to perform the PUCCH repetition. To indicate another PUCCH resource and corresponding spatial relation, preferably, the PUCCH spatial relation activation/deactivation MAC CE is manipulated by adding a second PUCCH resource ID (ID₁) with a corresponding reserved bit (R), and a second spatial field presented as S₁ᵢ bits, where i=0˜7. This approach can avoid the confusion in indicating more than one spatial relation.

In the manipulated MAC CE, the second PUCCH resource ID₁ is a 7-bit field identified by the high layer parameter PUCCH-ResourceId, and the second spatial field S₁ᵢ is identified by a high layer parameter PUCCH-SpatialRelationInfold. In an embodiment, when a second PUCCH spatial relation with PUCCH-SpatialRelationInfold equal to i+1 is activated, the i^{th} bit S₁ᵢ is set to 1. Conversely, the i^{th} bit S₁ᵢ is set to 0 as an indication that the second PUCCH spatial relation with PUCCH-SpatialRelationInfold equal to i+1 is deactivated. It is to be understood that the bit values is not limited to 0 and 1 as described in the embodiment and other value settings can be possible.

In a further embodiment, the corresponding reserved bit R can be used to indicate the UE whether a second PUCCH resource ID needs an activation. Preferably, if the reserved bit R of PUCCH resource ID₁ is set to 1, the second PUCCH resource indicator is indicated by the index PUCCH resource ID₁ and the corresponding spatial relation would be activated/deactivated according to the Spatial field S₁ᵢ. Conversely, if the reserved bit R is set to 0, the UE is indicated to ignore the PUCCH resource ID₁ and the corresponding spatial relation as if the fields are disabled.

FIG. 6 shows another manipulation of the PUCCH spatial relation activation/deactivation MAC CE. In FIG. 6, only one PUCCH resource ID is added to the PUCCH spatial relation activation/deactivation MAC CE, so that the size of the MAC CE is not as large as the previous embodiment. The Sᵢ bit is rearranged to indicate the two spatial relations for the two PUCCH resources. In FIG. 6, if the reserved bit R of the PUCCH resource ID₁ is set to 1, the value of PUCCH resource ID₁ is extracted to be the second PUCCH resource indicator, and the activation/deactivation statuses of corresponding spatial relation are determined based on the spatial field Sᵢ, where i=0˜7. Conversely, if the reserved bit R of the PUCCH resource IDᵢ is set to 0, the UE would not process the information in the PUCCH resource ID₁ and the corresponding spatial field Sᵢ.

A mapping relationship between the Sᵢ bit and the two PUCCH resources can be redefined so that two spatial relations are presented by a single Sᵢ bit in the spatial field. For example, the Sᵢ bit with the index i in a first range represent spatial relations for the first PUCCH resource, and likewise, those in a second range represent that of the second PUCCH resource. For example, the Sᵢ bits with i=0˜3 (first portion) are used for indicating the spatial relation for the first PUCCH resource, and the Sᵢ bits with i=4˜7 (second portion) are used for indicating the spatial relation for the second PUCCH resource. It is to be understood that the Sᵢ bit is not limited to the exemplary ranges. A variation can be still within the spirit and scope of the invention. For example, the first and second ranges can be reversed/varied to indicate the first/second spatial relations.

Even though this approach would limit the flexibility in configuration of spatial relation, such an embodiment is particularly useful for the scenario with limited spatial diversity.

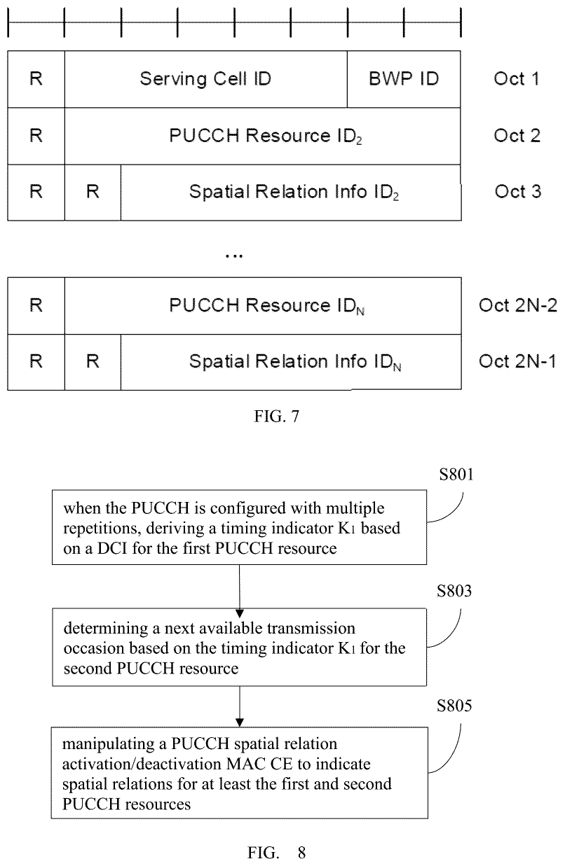

FIG. 7 shows an enhanced PUCCH spatial relation activation/deactivation MAC CE according to an embodiment of the invention, which is reused to serve as a group based MAC CE. In order to reduce signaling overhead and latency, PUCCH resources can be grouped. Conventionally, up to four groups of PUCCH resource can be configured for each BWP by the high layer signaling. The group based MAC CE is designed based on the architecture of “enhanced PUCCH spatial relation activation/deactivation MAC CE” to simultaneously activate and deactivate a spatial relation for a group of PUCCH resource to support multiple spatial relations, including reuse and update of the multiple spatial relations. The group based MAC CE can be further enhanced to update multiple spatial relations each corresponding to an individual PUCCH resource, wherein each spatial relation can be different.

To support multiple PUCCH resources with the associated spatial relations, the embodiment proposes to indicate the first PUCCH resource by a DCI, and indicate the second PUCCH resource by the group based MAC CE, wherein the first and the second PUCCH resources in the embodiment are regarded in the same PUCCH resource group. When the UE is configured to conduct PUCCH repetition(s), the UE extracts a K₁ from the DCI for the first PUCCH resource and then determines the next available transmission occasion for the second PUCCH resource based on the K₁.

As shown in FIG. 7, if the reserved bit R of the second PUCCH resource ID₂ is set to 1, the value in the second PUCCH resource ID₂ is extracted to be the second PUCCH resource indicator, and the corresponding spatial relation would be activated/deactivated based on the corresponding spatial relation info ID₂. Conversely, if the reserved bit R of the second PUCCH resource ID₂ is set to 0, the UE ignores the second PUCCH resource ID₂ and the corresponding Spatial Relation Info ID₂. If more PUCCH resources are needed, more field pairs of PUCCH resource ID_{N} and PUCCH spatial relation info ID_{N} can be appended to the group based MAC CE. By combination of the DCI and the grouped MAC CE, the UE can efficiently obtain essential information required for PUCCH repetition/transmission in the multi-TRP/panel systems. This approach can significantly reduce the overhead and latency, especially when the number of PUCCH resource is large.

FIG. 8 is a flowchart of configuration/activation of multiple spatial relations according to an embodiment of the invention. The embodiments in FIGS. 5-7 can be summarized as the following steps. In step S801, when PUCCH repetition is configured, a timing indicator K₁ is derived based on a DCI. In step S803, a next available transmission occasion is determined based on the timing indicator K₁. In step S805, a PUCCH spatial relation activation/deactivation MAC CE is manipulated to indicate at least the first and second PUCCH resources and corresponding spatial relations.

For services that require low feedback latency, an intra-slot PUCCH repetition can be implemented to attend both reliability and latency, for example, by transmitting a PUCCH within one slot (i.e., a set of symbols). Various potential issues may be induced when intra-slot PUCCH repetition is to be implemented in multi-TRP/panel based systems. In the third aspect of the invention, intra-slot PUCCH repetition is enabled in multi-TRP/panel based systems by defining flexible overlap rules between intra-slot PUCCH and other PUCCH.

To improve reliability, a PUCCH transmission can be repeated with different spatial relations towards different TRPs. The transmission of multiple PUCCH repetitions performed in different sub-slots (i.e. a set of symbols) within one slot, is advantageous for relatively low latencies. Therefore, intra-slot PUCCH repetition (i.e. symbol level repetition) is particularly suitable for the services that require low feedback latency and high reliability.

In an intra-slot PUCCH repetition mechanism, the number of repetitions requires an indication mechanism. In an embodiment, the number of repetitions is indicated by the high layer parameters. In conventional inter-slot PUCCH repetition disclosed in Rel-15, the number of repetitions is configured by the high layer for each PUCCH format. In comparison, the inter-slot and intra-slot PUCCH repetitions are respectively suitable for different traffic types and scenarios. Hence, it is preferable to employ two individual fields to indicate the numbers of inter-slot PUCCH repetition and intra-slot PUCCH repetition, respectively. Therefore, the embodiment proposes to define the two fields in the high layer signaling.

Alternatively, to reduce the signaling overhead, a preferred embodiment provides only one field to indicate the number of these two repetition types, wherein the field is also defined in the high layer signaling.

In a further embodiment, the number of repetitions is indicated by the MAC CE. Considering that the number of repetitions configured by the high layer may not be suitable for different scenarios, especially when signaling to the UE while the channel changes dynamically. But if a number of repetitions is configured by the high layer, MAC CE can be a flexible medium to deliver the info to the UE. In an embodiment to implement the MAC CE, several bits are added to indicate a dedicated number of repetitions.

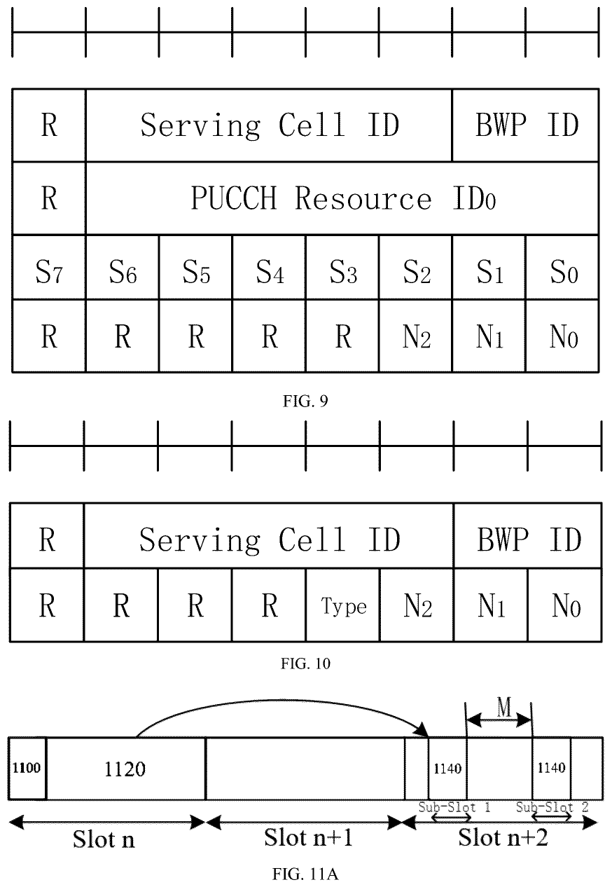

FIG. 9 shows a manipulation of the PUCCH spatial relation activation/deactivation MAC CE for indicating the number of repetitions according to an embodiment of the invention. By enhancing the PUCCH spatial relation activation/deactivation MAC CE, the N₀/N₁/N₂ fields (bits) are used to indicate the values 2/4/8, respectively. If one of those fields is set to 1, the corresponding value is used, otherwise, the field is ignored.

FIG. 10 shows an alternative MAC CE for indicating the number of repetitions according to an embodiment of the invention. In FIG. 10, a type field is defined in the MAC CE to discriminate the inter-slot repetition from the intra-slot repetition. If the type field is set to 1 for the intra-slot repetition, and 0 for the inter-slot repetition vice versa. The N₀, N₁, and N₂ fields are defined to respectively indicate the values 2, 4, and 8. If one of the fields is set to 1, the corresponding value is used. The UE would ignore the fields of value 0. It is to be understood that the values in the type field is not limited, and an alternative/variation is possible. For example, the type field may be 0 for inter-slot repetition, and 1 for intra-slot repetition.

In an embodiment, the number of repetitions can be overridden by an actual number of repetitions. When the number of repetitions is configured by the high layer, the MAC CE further provides an indication of actual numbers for the inter-slot/intra-slot PUCCH repetitions. The actual number of repetitions is not larger than the number of repetitions configured by high layer. For example, if number of repetitions configured by the high layer is 8, the actual number of repetitions indicated by the MAC CE can be 2, 4, or 8.

Embodiments for indicating the repetition types are proposed. Since there may be at most two types (i.e. inter-slot and intra-slot repetition) of PUCCH repetition, there is a need to discriminate the repetition types during PUCCH transmissions.

In an embodiment, two different fields may be employed to indicate the number of repetitions respective to the two repetition types. The repetition type can also be represented based on the two fields. For example, if only one field is greater than 1, the type corresponding to the field is used to indicate the repetition type of the PUCCH repetition.

In a further embodiment, the PUCCH format is concerned. Generally, different PUCCH formats are best adaptable for different repetition types, i.e., the short PUCCH format is suitable for intra-slot PUCCH repetition, while the long PUCCH format is suitable for the inter-slot PUCCH repetition. A preferred embodiment proposes that the repetition type can be indicated by the PUCCH format. For example, the short PUCCH (e.g. format 0, 2) indicates the intra-slot repetition and long PUCCH (e.g. format 1,3,4) indicates inter-slot repetition.

In some cases where the repetition type cannot be implicitly indicated, one field may be added to explicitly indicate the repetition type (i.e. inter-slot or inter-slot repetition). The field may be added in the high layer signaling/MAC CE/DCI. In an embodiment, the field can be set to 1 for the intra-slot repetition, and 0 for the inter-slot repetition vice versa. Such an explicit approach enables the possibility of dynamic switching between the inter-slot and intra-slot PUCCH repetition. It is to be understood that any alternative arrangement of the field values for indicating the repetition types is also within the scope of the invention.

To implement the intra-slot PUCCH repetition in the multi-TRP/panel systems, the first symbol of each PUCCH repetition shall be concerned.

Let N represent the number of repetitions, PUCCH transmissions in each of the N sub-slots consume the same number of consecutive symbols. The number of consecutive symbols can be defined by a high layer parameter nrofSymbols. Regarding the first symbol for inter-slot PUCCH repetition, the high layer parameter startingSymbolIndex in the corresponding PUCCH format configuration uses the beginning of the slot as the reference point. For the case of intra-slot PUCCH repetition, however, since the transmissions are repeated within one slot, the indication of the first symbol does not make any sense. Therefore, the high layer parameter startingSymbolIndex may only be adapted in the first PUCCH repetition. That is, the first symbol for the first repetition starts at the startingSymbolIndex-th symbol from the beginning of the slot indicated by K₁. As for the second and remaining repetitions, the first symbol is defined by alternative embodiments as provided below.

In an embodiment, the first symbol of the second and remaining repetitions is defined based on the high layer parameter startingSymbolIndex.

FIG. 11A shows time slots of a PDCCH 1100, a PDSCH 1120 and two PUCCHs 1140 according to an embodiment of the invention. The end of the last repetition is regarded as a reference point, and the first symbol of the second and remaining repetitions is M symbols from the reference point. The value M is based on (equal to) the high layer parameter startingSymbolIndex.

Alternatively, if the beginning of a dedicated symbol is regarded as the reference point, likewise, the first symbol of the second and remaining repetitions is M symbols from the reference point, wherein the value M is equal to the high layer parameter startingSymbolIndex. Specifically, a series of reference points can be configured for the second and remaining repetitions, indicated by the high layer parameter, the MAC CE, or the DCI. In a further embodiment, reference points can be allocated in a regular pattern. Taking the second and third repetitions as an example, a middle symbol of a slot indicated by K₁ is regard as a reference point for the second repetition, and the first symbol of the next slot is regard as a reference point for the third repetition. Such a reference point allocation for the pair of second and third repetitions may form a regular pattern recursively applied in sequence to the remaining repetitions.

FIG. 11B shows time slots of a PDCCH 1100, a PDSCH 1120 and two PUCCHs 1140 according to an embodiment of the invention. In FIG. 11B, the first symbol of the second and remaining repetitions may be defined based on a parameter Gab. If the end of the last repetition is regarded as the reference point, it is proposed that the first symbol of the second and remaining repetitions is allocated at Gab symbols after the end of the last repetition, wherein the parameter Gab can be indicated by the high layer parameter, the MAC CE, or the DCI. In an embodiment for signaling the parameter Gab, a new field may be added to indicate the value of Gab to the UE.

In a case where the beginning of a dedicated symbol is regarded as the reference point, it is proposed that the first symbol of the second and remaining repetitions is allocated at Gab symbols after the beginning of the dedicated symbol, wherein the value Gab is indicated by the high layer parameter, the MAC CE, or the DCI. Furthermore, a series of reference points can be configured for the second and remaining repetitions, wherein the series of reference points may be indicated by the high layer parameter, the MAC CE, or the DCI. Reference points can be allocated in a regular pattern. For example, the middle symbol of the slot indicated by K₁ is regard as a reference point for the second repetition, whereas the first symbol of the next slot is regard as a reference point for the third repetition. The reference point allocation in the pair of the second and third repetitions forms a pattern that is recursively appliable to the remaining repetition pairs.

Moreover, if a UE transmits a PUCCH over a span of N sub-slots but does not transmit the PUCCH in one sub-slot from the N sub-slots due to overlapping (confliction) with another PUCCH transmission in the sub-slot, the UE still counts the conflicting sub-slot in the number of N sub-slots.

Embodiments of Intra-slot PUCCH repetition overlapping with other PUCCH are described hereafter.

In Rel-15, the priorities of a first PUCCH and at least a second PUCCH are defined, wherein the first PUCCH occupies more than one slot, and the second PUCCH occupies one or more slots. The first PUCCH and the second PUCCH may be overlapped on a number of slots. Conventionally, UCI types reported in a PUCCH include HARQ-ACK information, SR, LRR, and CSI. A priority rule is basically defined based on the UCI types, where the UCI priorities are: HARQ-ACK>SR>CSI with higher priority>CSI with lower priority. A PUCCH transmission from the UE is basically dependent on the priority rule and the starting slot of the PUCCH. However, the priority rule is defined on the slot basis that may not be suitable for the sub-slot based transmissions.

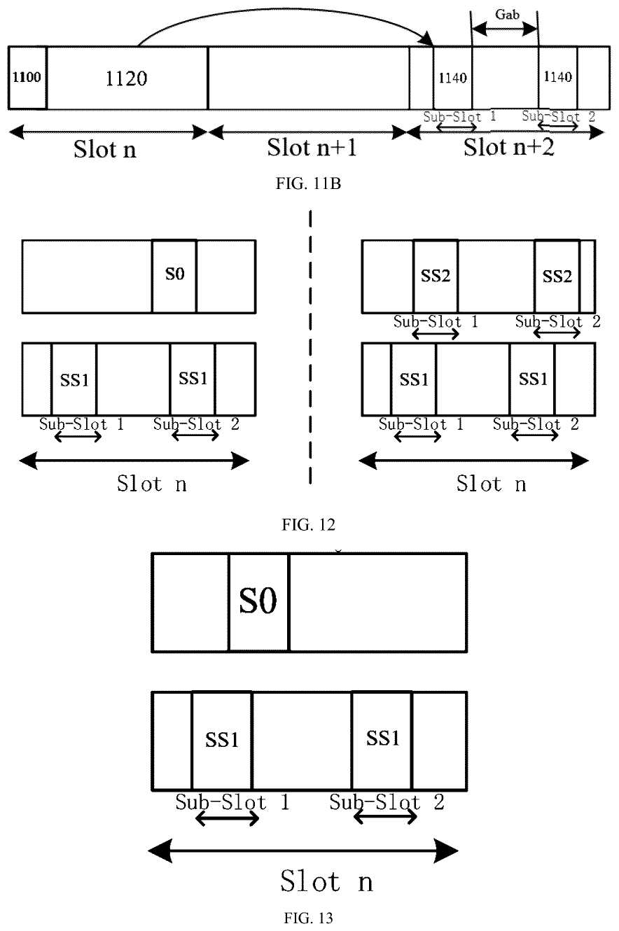

FIG. 12 shows time slots where two PUCCHs starting at different symbols in the same slot according to an embodiment of the invention. The left part shows a slot based PUCCH S0 and a sub-slot based PUCCH1 with two repetitions SS1. The right part shows the sub-slot based PUCCH1 with two repetitions SS1, and a second slot-based PUCCH2 with two repetitions SS2. On intra-slot PUCCH repetition, a PUCCH transmission can be repeated within one slot, and different sub-slot based PUCCH transmissions can be distinguished by the start symbols thereof. In the case when a sub-slot PUCCH and at least one second PUCCH are of the same priority, the sub-slot PUCCH and any of the second PUCCH can start at the same slot to reduce latency. Technically, however, it is not allowed for two transmissions to start at the same symbol. As is shown in FIG. 12, it is possible for two PUCCHs to start at different symbols in the same slot.

In the case when the UE transmits a first sub-slot PUCCH with more than one sub-slot and at least a second PUCCH with one or more slots/sub-slots, with some sub-slots thereof overlapped to each other, embodiments of an overlap rule are proposed, including several scenarios described as below.

In the case that the first PUCCH and any of the second PUCCHs are of different priorities, embodiments of the overlap rule are proposed with the following alternatives.

In an embodiment, the overlap rule may be defined based on priority per sub-slot. To reduce latency and transmit more PUCCHs in one slot, the overlap rule is defined for each overlapping sub-slot in one slot. Preferably, in each overlapping sub-slot, a PUCCH of higher priority is transmitted, whereas those with lower priorities are not. Besides, if there is any other non-overlapping PUCCH in the slot, this PUCCH is transmitted.

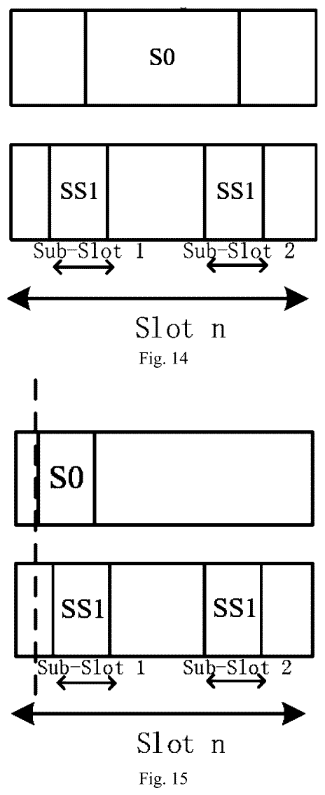

FIG. 13 shows time slots for a slot based PUCCH S0 and a sub-slot based PUCCH with two repetitions SS1 according to an embodiment of the invention. As shown in FIG. 13, one repetition SS1 of the sub-slot based PUCCH is overlapped with a slot based PUCCH S0 of higher priority. The sub-slot based PUCCH repeats twice in the slot n. Based on the overlapping rule, the slot based PUCCH S0 is transmitted, followed by the second repetition SS1 of the sub-slot based PUCCH in slot n.

In an alternative embodiment, the overlap rule may be defined per slot. To simplify scheduling of the PUCCH and the UE behavior, the same priority is applied to all sub-slot repetitions of the same PUCCH in one slot. In one proposed embodiment, if a PUCCH has the highest priority compared with the any of other PUCCHs in corresponding overlapping sub-slots, all the sub-slot PUCCHs of the PUCCH are transmitted and any of the other PUCCHs is not transmitted.

Also as shown in FIG. 13, the slot based PUCCH S0 has a higher priority. Based on the per slot overlap rule, the slot based PUCCH S0 is transmitted while the two repetitions SS1 of the sub-slot PUCCH are not transmitted in slot n.

In a further embodiment, a deferral mechanism is proposed to make the best use of any available sub-slots, so as to transmit as many PUCCHs as possible in one slot. For a PUCCH having a lower priority, the PUCCH is saved or buffered as a deferred PUCCH. A vacancy duration is determined from the end of the higher priority PUCCH to the starting of a next higher priority (prioritized) PUCCH in the same slot, or from the end of the higher priority PUCCH to the end of the slot if there is no other prioritized PUCCH thereafter. If the number of consecutive symbols of the deferred PUCCH is small enough to fit in the vacancy duration, the deferred PUCCH is transmitted in the vacancy duration after the higher priority PUCCH finishes transmission.

If a first sub-slot PUCCH and any of the second PUCCHs are on the same priority, the overlap rule may consider three scenarios, per sub-slot base, per slot base, and transmission deferral.

Embodiments of the overlap rule defined per sub-slot is described. To reduce latency and transmit more PUCCHs in one slot, the overlap rule is defined for each overlapping sub-slot in one slot. It is proposed that for each overlapping sub-slot, if a PUCCH overlaps with two PUCCHs in different sub-slots, only the PUCCH in the sub-slot with an earlier start symbol is processed. To further define the overlap rule, it is proposed that the PUCCH starting at an earlier symbol is transmitted whereas the PUCCH starting at a later symbol is dropped.

Besides, if there is any other non-overlapping PUCCH in the slot, this PUCCH is transmitted.

FIG. 14 shows time slots for a slot based PUCCH S0 and a sub-slot based PUCCH with two repetitions SS1 when the priorities are the same. In slot n, a slot based PUCCH S0 overlaps a sub-slot PUCCH of two repetitions SS1 at two different sub-slots. Only the first repetition SS1 is considered because it starts at an earlier symbol. Therefore, the first repetition SS1 of the sub-slot PUCCH is transmitted and the slot based PUCCH S0 is not transmitted and dropped. Since the slot based PUCCH S0 is not transmitted and dropped, the second repetition SS1 of the sub-slot PUCCH becomes non-overlapping and can be transmitted.

Embodiments of the overlap rule defined per slot is described. To schedule the PUCCH per slot and simplify the UE behavior, all the repetition of the first PUCCH in one slot shall have equal opportunity to be transmitted or not. An overlap rule may prescribe that if the first repetition of the first PUCCH starting at an earlier symbol, all the sub-slot PUCCH of the first PUCCHs are transmitted and any of the second PUCCHs is not transmitted. Otherwise, all the sub-slot PUCCH of the first PUCCHs are not transmitted and the PUCCH of the second PUCCHs that starts at an earlier symbol is transmitted.

FIG. 15 shows time slots for a slot based PUCCH S0 and a sub-slot based PUCCH with two repetitions SS1 when priorities are the same. As is shown in FIG. 15, a slot based PUCCH S0 is partially overlapped with a first repetition SS1 of a sub-slot based PUCCH wherein the slot based PUCCH S0 starts at an earlier symbol. According to the described overlap rule, the slot based PUCCH S0 is transmitted, and all repetitions SS1 of the sub-slot PUCCH are not transmitted and/or dropped in slot n.

A deferral mechanism can be prescribed in the overlap rule to make the best use of any available sub-slots, so as to transmit as many PUCCHs as possible in one slot. For a PUCCH having a later start symbol, the PUCCH is saved or buffered as a deferred PUCCH. A vacancy duration is determined from the end of the early started PUCCH to the starting of a next PUCCH in the same slot, or from the end of the early started PUCCH to the end of the slot if there is no other PUCCH thereafter. If the number of consecutive symbols of the deferred PUCCH is small enough to fit in the vacancy duration, the deferred PUCCH is transmitted in the vacancy duration after the early started PUCCH finishes transmission.

With the proposed deferral mechanism, the dropped sub-slot PUCCHs in FIG. 15 can be transmitted instead of being dropped, which significantly increases the transmission efficiency of the slot. It is shown that the vacancy duration is sufficient for both the first sub-slot PUCCH and the second sub-slot PUCCH.

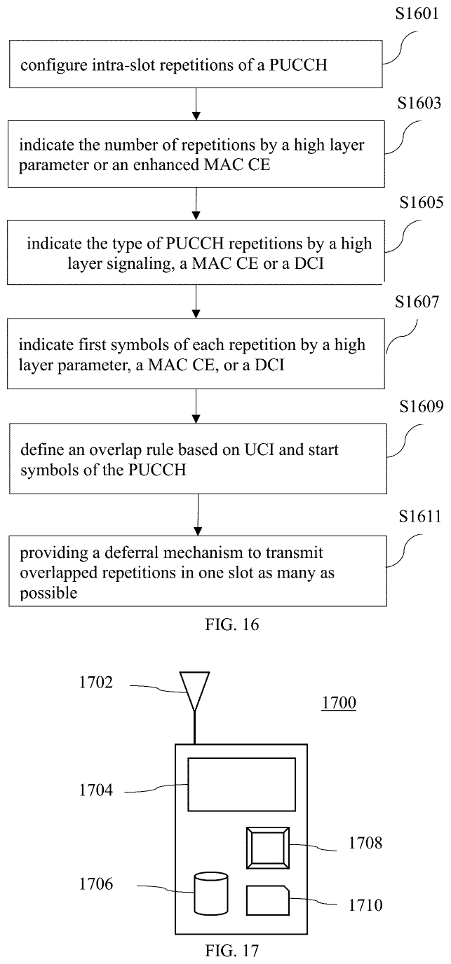

FIG. 16 is a flowchart summarizing the steps implemented in intra-slot repetition according to embodiments of the invention. The described embodiments from FIG. 9 to FIG. 15 can be summarized in the flowchart. In step S1601, intra-slot repetitions of a PUCCH is configured for a UE in the multi-TRP/panel system. In step 1603, the number of repetitions may be indicated by a high layer parameter or an enhanced MAC CE. In step S1605, the type of PUCCH repetitions may be indicated by a high layer signaling, a MAC CE, or a DCI. In step 1607, the first symbols of each repetition may be indicated by a high layer parameter, a MAC CE, or a DCI. In step 1609, an overlap rule may be defined based on UCI and start symbols of the PUCCH. In step S1611, a deferral mechanism can be provided to transmit the repetitions being deferred by the overlap rule, so that as many repetitions can be transmitted in one slot as possible.

FIG. 17 is a diagram of a UE 1700 according to the embodiment of the application. The UE 1700 generally comprises a transceiver 1702, a display 1704, a storage 1706, a processor 1708 and a Subscriber Identity Module (SIM) card 1710. The transceiver 1702 is also known as an RF module comprising a transmitter (Tx) and a receiver (Rx), functional for both signal transmissions and receptions since the hardware structure of the transmitter and the receiver can be shared and integrated into one module. The embodiment of the adaptive feedback mechanism is basically software implementations that are presented as software or firmware stored in the storage 1706, and executed by the processor 1708. Therefore, there is no specific limitation in the hardware structure of the UE 1700, which can be a phone, a tablet, a computer, a video streaming device, a set top box or any subscriber enabled communication device. It is to be understood that the transmission method as claimed are jointly implemented by the multi-TRP/panel system and the UE. No physical hardware are manipulated during execution of the steps of the transmission method. The proposed transmission method enables the UE to be efficiently operated in the multi-TRP/panel system particularly when transmitting multiple PUCCH repetitions toward different TRPs.

It is to be understood that all the values or ranges being specified in the embodiments are merely design choices and the scope of the invention is not limited thereto. All the number or values can be reasonably varied or rearranged without deviating the spirit of the proposed invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A transmission method for a UE operatable in a multi-TRP/panel system comprising a plurality of TRPs and a high layer, comprising:
when the high layer indicates that (S401) a default spatial relation for a PUCCH to be transmitted is enabled while the UE is not configured with any spatial relation for the PUCCH, performing a default spatial relation assumption (S201) to determine the default spatial relation; and
performing a PUCCH transmission (S403) from the UE towards the plurality of TRPs based on the default spatial relation.

2. The transmission method according to claim 1, wherein when the high layer indicates that a default spatial relation for a PUCCH to be transmitted is enabled while the UE is not configured with any spatial relation for the PUCCH, the transmission method further comprises:
if the UE is configured with PUCCH repetition when the default spatial relation is configured to the PUCCH, the default spatial relation is analogically applied to each PUCCH transmission of the repetitions.

3. The transmission method according to claim 1, wherein when the high layer indicates that a default spatial relation for a PUCCH to be transmitted is enabled while the UE is not configured with any spatial relation for the PUCCH, the transmission method further comprises:
when multiple PDCCH repetitions of a PDCCH are transmitted by different TRPs, determining a CORESET of lowest CORESET ID in a most recent monitored search space; and
performing the default spatial relation assumption to determine the default spatial relation based on a spatial setting for PDCCH receptions by the UE in the CORESET of lowest ID, wherein:
if the CORESET of lowest CORESET ID comprises two active TCI states, the spatial setting is corresponded to one of the two TCI states having a lower TCI state ID.

4. The transmission method according to claim 1, wherein when the high layer indicates that a default spatial relation for a PUCCH to be transmitted is enabled while the UE is not configured with any spatial relation for the PUCCH, the transmission method further comprises:
if a PDCCH candidate is defined in two different CORESETs each corresponding to an active TCI state:
determining a CORESET of lowest CORESET ID in a most recent monitored duration of the two different CORESETs; and
performing the default spatial relation assumption to determine the default spatial relation based on a spatial setting for PDCCH receptions by the UE in the CORESET of lowest CORESET ID on the active DL BWP.

5. The transmission method according to claim 1, wherein when the high layer indicates that a default spatial relation for a PUCCH to be transmitted is enabled while the UE is not configured with any spatial relation for the PUCCH, the transmission method further comprises:
determining a PDCCH candidate of lowest ID from a most recent monitored search space;
if the PDCCH candidate is associated with one TCI state, corresponding a spatial setting for the PDCCH reception to the TCI state;
if the PDCCH candidate is associated with two TCI states, corresponding the spatial setting to one of the two TCI states having a lower TCI state ID; and
performing the default spatial relation assumption to determine the default spatial relation based on the spatial setting.

6-8. (canceled)

9. The transmission method according to claim 1, further comprising:
when the UE is configured with one or more PUCCH repetitions, configuring one or more spatial relations for each PUCCH repetition; and
transmitting the PUCCH repetitions towards corresponding TRPs based on the one or more spatial relations respectively.

10-13. (canceled)

14. The transmission method according to claim 1, further comprising:
when the UE is configured with one or more PUCCH repetitions (S1601), configuring a number of repetitions (S1603) to perform an intra-slot PUCCH repetition for the PUCCH;
wherein: the number of repetitions is indicated by the high layer.

15-19. (canceled)

20. The transmission method according to claim 1, wherein when the UE is configured with one or more PUCCH repetitions, the transmission method further comprises:
when an intra-slot PUCCH repetition is configured for a first PUCCH repetition, using a high layer parameter startingSymbolIndex to indicate the first PUCCH repetition (S1607), wherein:
a first symbol of the first PUCCH repetition is startingSymbolIndex symbols from the beginning of the slot indicated by the timing indicator K1.

21-30. (canceled)

31. A multi-TRP/panel system comprising a plurality of TRPs and a high layer, connectible to a UE comprising a processor, a memory, a storage medium, a transmitter, and a receiver, corporately performing a method for transmission, wherein:
when the high layer indicates that a default spatial relation for a PUCCH to be transmitted from the UE is enabled while the UE is not configured with any spatial relation for the PUCCH, the UE performs a default spatial relation assumption to determine the default spatial relation; and
the UE performing a PUCCH transmission towards the plurality of TRPs based on the default spatial relation.

32. (canceled)

33. The multi-TRP/panel system according to claim 31, wherein:
the multi-TRP/panel system configures the UE with one or more PUCCH repetitions, and configures one or more spatial relations for each PUCCH repetition, so that the UE transmits the PUCCH repetitions towards corresponding TRPs based on the one or more spatial relations respectively.

34-37. (canceled)

38. The multi-TRP/panel system according to claim 31, wherein when the multi-TRP/panel system configures the UE with one or more PUCCH repetitions, the high layer indicates the UE a number of repetitions so that the UE is triggered to perform an intra-slot PUCCH repetition for the PUCCH.

39-43. (canceled)

44. The multi-TRP/panel system according to claim 31 wherein when the UE is configured with one or more PUCCH repetitions, the multi-TRP/panel system further uses a high layer parameter startingSymbolIndex to indicate the first PUCCH repetition when an intra-slot PUCCH repetition is configured for a first PUCCH repetition, wherein: a first symbol of the first PUCCH repetition is startingSymbolIndex symbols from the beginning of the slot indicated by the timing indicator K1.

45-52. (canceled)

54. A UE operatable in a multi-TRP/panel system comprising a plurality of TRPs and a high layer, comprising a processor, a memory, a storage medium, a transmitter, and a receiver; wherein:
when the high layer indicates that a default spatial relation for a PUCCH to be transmitted is enabled while the UE is not configured with any spatial relation for the PUCCH, the UE performs a default spatial relation assumption to determine the default spatial relation; and
the UE transmits a PUCCH towards the plurality of TRPs based on the default spatial relation.

55. The UE according to claim 54, wherein when the high layer indicates that a default spatial relation for a PUCCH to be transmitted is enabled while the UE is not configured with any spatial relation for the PUCCH, if the UE is configured with PUCCH repetition when the default spatial relation is configured to the PUCCH, the UE analogically applies the default spatial relation to each PUCCH transmission of the repetitions.

56. The UE according to claim 54, wherein when the high layer indicates that a default spatial relation for a PUCCH to be transmitted is enabled while the UE is not configured with any spatial relation for the PUCCH:
when multiple PDCCH repetitions of a PDCCH are transmitted by different TRPs, a CORESET of lowest CORESET ID is determined in a most recent monitored search space; and
the UE performs the default spatial relation assumption to determine the default spatial relation based on a spatial setting for PDCCH receptions by the UE in the CORESET of lowest ID, wherein:
if the CORESET of lowest CORESET ID comprises two active TCI states, the spatial setting is corresponded to one of the two TCI states having a lower TCI state ID.

57. The UE according to claim 54, wherein when the high layer indicates that a default spatial relation for a PUCCH to be transmitted is enabled while the UE is not configured with any spatial relation for the PUCCH:
if a PDCCH candidate is defined in two different CORESETs each corresponding to an active TCI state, a CORESET of lowest CORESET ID determined in a most recent monitored duration of the two different CORESETs; and
the UE performs the default spatial relation assumption to determine the default spatial relation based on a spatial setting for PDCCH receptions by the UE in the CORESET of lowest CORESET ID on the active DL BWP.

58. The UE according to claim 54, wherein when the high layer indicates that a default spatial relation for a PUCCH to be transmitted is enabled while the UE is not configured with any spatial relation for the PUCCH:
a PDCCH candidate of lowest ID is determined in a most recent monitored search space;
if the PDCCH candidate is associated with one TCI state, a spatial setting for the PDCCH reception is corresponded to the TCI state;
if the PDCCH candidate is associated with two TCI states, the spatial setting is corresponded to one of the two TCI states having a lower TCI state ID; and
the UE performs the default spatial relation assumption to determine the default spatial relation based on the spatial setting.

59-61. (canceled)

62. The UE according to claim 54, wherein:
when the UE is configured with one or more PUCCH repetitions, one or more spatial relations are configured for each PUCCH repetition; and
the UE transmits the PUCCH repetitions towards corresponding TRPs based on the one or more spatial relations respectively.

63-66. (canceled)

67. The UE according to claim 54, wherein when the UE is configured with one or more PUCCH repetitions, a number of repetitions is configured to perform an intra-slot PUCCH repetition for the PUCCH; wherein: the number of repetitions is indicated by the high layer.

68-72. (canceled)

73. The UE according to claim 54, wherein when the UE is configured with one or more PUCCH repetitions, when an intra-slot PUCCH repetition is configured for a first PUCCH repetition, a high layer parameter startingSymbolIndex is used to indicate the first PUCCH repetition, wherein:
a first symbol of the first PUCCH repetition is startingSymbolIndex symbols from the beginning of the slot indicated by the timing indicator K1.

74-83. (canceled)
